(19) United States
(12) Patent Application Publication
(10) Pub. No.: US 2023/0156719 A1
(43) Pub. Date: May 18, 2023

(54) CORESET ENHANCEMENT FOR REDUCED BANDWIDTH UEs

(71) Applicant: Telefonaktiebolaget LM Ericsson (publ), Stockholm (SE)

(72) Inventors: Mohammad Mozaffari, Fremont, CA (US); Yutao Sui, Solna (SE); Yi-Pin Eric Wang, Fremont, CA (US); Saeedeh Moloudi, Linköping (SE); Olof Liberg, Enskede (SE); Johan Bergman, Stockholm (SE); Anders Wallén, Ystad (SE); Andreas Höglund, Solna (SE); Riikka Susitaival, Helsinki (FI)

(21) Appl. No.: 17/915,127

(22) PCT Filed: Mar. 29, 2021
(86) PCT No.: PCT/SE2021/050277

§ 371 Date: Sep. 28, 2022

Related U.S. Application Data
(60) Provisional application No. 63/002,993, filed on Mar. 31, 2020.

(51) Int. Cl. H04W 72/23; H04W 72/1263; H04L 5/00

(52) U.S. Cl. CPC H04W 72/23; H04W 72/1263; H04L 5/0094

(57) ABSTRACT

Systems and methods are disclosed herein for control resource set (CORESET) enhancements that are particularly beneficial for reduced bandwidth wireless communication devices. Embodiments of a method performed by a wireless communication device for a cellular communications system are disclosed. In one embodiment, a method performed by a wireless communication device for a cellular communications system comprises receiving, from a network node, information that configures a CORESET for the wireless communication device, the CORESET comprising four or more symbols in the time domain. The method further comprises receiving a physical downlink control channel (PDCCH) transmission from the network node within a search space that comprises at least a subset of time-frequency resources within the CORESET. In this manner, the CORESET is enhanced in a way that is particularly beneficial for reduced bandwidth wireless communication devices. Corresponding embodiments of a network node are also disclosed.

### RELATED APPLICATIONS

This application claims the benefit of provisional patent application Ser. No. 63/002,993, filed Mar. 31, 2020, the disclosure of which is hereby incorporated herein by reference in its entirety.

### TECHNICAL FIELD

The present disclosure relates to a cellular communications system and, more specifically, to a Control Resource Set (CORESET) utilized in a cellular communications system.

### BACKGROUND

The next paradigm shift in processing and manufacturing is the Industry 4.0 in which factories are automated and made much more flexible and dynamic with the help of wireless connectivity. This includes real-time control of robots and machines using time-critical Machine-Type Communication (cMTC) and improved observability, control, and error detection with the help of large numbers of more simple actuators and sensors (massive machine-type communication or mMTC).

For cMTC support, Ultra-Reliable Low-Latency Communication (URLLC) was introduced in Third Generation Partnership Project (3GPP) Release 15 for both Long Term Evolution (LTE) and New Radio (NR). NR URLLC is further enhanced in Release 16 within the enhanced URLLC (eURLLC) and Industrial Internet of Things (IoT) work items.

For mMTC and Low Power Wide Area (LPWA) support, 3GPP introduced both narrowband Internet-of-Things (NB-IoT) and LTE for Machine-Type Communication (LTE-MTC, or LTE-M) in Release 13. These technologies have been further enhanced through all releases up until and including the ongoing Release 16 work.

NR was introduced in 3GPP Release 15 and focused mainly on the enhanced Mobile Broadband (eMBB) and cMTC. For Release 17, however, an NR User Equipment (UE) type with lower capabilities will likely be introduced since it is supported and proposed by many companies. The intention is to have an MTC version of NR, i.e. Reduced Capability NR (NR-RedCap) device (also referred to herein as an NR-RedCap UE), which is mid-end, filling the gap between eMBB NR and NB-IoT/LTE-M, e.g., to provide more efficient in-band operation with URLLC in industrial use cases.

Low-cost or low-complexity UE implementation is needed for the Fifth Generation (5G) system, e.g., for massive industrial sensors deployment or wearables. Currently, NR-RedCap is used as the running name for the discussion of such low-complexity UEs in 3GPP (see RP-193238 for more detail). NR-RedCap is a new feature that is currently under discussion and could be introduced as early as in 3GPP Release 17. A NR-RedCap device is intended for use cases that do not require a device to support full-fledged NR capability and IMT-2020 performance requirements. For example, the data rate does not need to reach above 1 Gigabits per second (Gbps), and the latency does not need to be as low as 1 millisecond (ms). By relaxing the data rate and latency targets, NR-RedCap allows low-cost or low-complexity UE implementation. In 3GPP Release 15, an NR UE is required to support 100 Megahertz (MHz) carrier bandwidth in frequency range 1 (from 410 MHz to 7125 MHz) and 200 MHz carrier bandwidth in frequency range 2 (from 24.25 GHz to 52.6 GHz). For NR-RedCap UEs, supporting 100 MHz or 200 MHz bandwidth is superfluous. For example, a UE bandwidth of 8.64 MHz might be sufficient if the use cases do not require a data rate higher than 20 Megabits per second (Mbps). Reduced UE bandwidth results in complexity reduction and possibly energy consumption reduction as well.

### NR CORESET and PDCCH

Physical Downlink Control Channel (PDCCH) carries Downlink Control Information (DCI). PDCCHs are transmitted in Control Resource Sets (CORESETs) which span over one, two, or three contiguous Orthogonal Frequency Division Multiplexing (OFDM) symbols over multiple Resource Blocks (RBs). In frequency domain, a CORESET can span over one or multiple chunks of six RBs. For CORESETs other than CORESET #0, multiple chunks of six RBs can be either contiguous or non-contiguous, and CORESETs are aligned with a six-RB grid (starting from reference Point A). CORESET #0, which is configured during the initial access, can only have 24, 48, or 96 RBs. Also, CORESET #0 must be contiguous in frequency domain, and it is not necessarily aligned with the six-RB grid. Note that CORESET #0 is the CORESET in which PDCCH for System Information Block (SIB) 1 (SIB1) is transmitted, where SIB1 is the minimum system information. CORESET #0 is itself configured using bits in the Master Information Block (MIB).

A PDCCH is carried by 1, 2, 4, 8, or 16 Control Channel Elements (CCEs). Multiple CCEs used for transmission of a DCI are referred to as an Aggregation Level (AL). Each CCE is composed of 6 Resource Element Groups (REGs), and each REG is 12 Resource Elements (REs) in one OFDM symbol, as shown in FIG. 1. A REG bundle consists of 2, 3, or 6 REGs. Thus, a CCE can be composed of one or multiple REG bundles. FIG. 1 illustrates an example of a CORESET (36 RBs and one symbol).

Each CORESET is associated with a CCE-REG mapping which can be interleaved or non-interleaved. In the non-interleaved case, all CCEs in an AL are mapped in consecutive REG bundles of the associated CORESET. In the interleaved case, REG bundles of CCEs are distributed on the frequency domain over the entire CORESET BW. For CORESET #0, the CCE-REG mapping is always interleaved with predefined parameters (see 3GPP Technical Specification (TS) 38.211, “NR; Physical channels and modulation”).

In order to receive DCI, a UE needs to blindly decode PDCCH candidates potentially transmitted from the network using one or more search spaces. A search space consists of a set of PDCCH candidates where each candidate can occupy multiple CCEs. The number of CCEs used for a PDCCH candidate is referred to as AL which in NR can be 1, 2, 4, 8, or 16. A higher AL provides higher coverage.

### SUMMARY

Systems and methods are disclosed herein for control resource set (CORESET) enhancements that are particularly beneficial for reduced bandwidth wireless communication devices. Embodiments of a method performed by a wireless communication device for a cellular communications system are disclosed. In one embodiment, a method performed by a wireless communication device for a cellular communications system comprises receiving, from a network node, information that configures a CORESET for the wireless communication device, the CORESET comprising four or more symbols in the time domain. The method further comprises receiving a physical downlink control channel (PDCCH) transmission from the network node within a search space that comprises at least a subset of time-frequency resources within the CORESET. In this manner, the CORESET is enhanced in a way that is particularly beneficial for reduced bandwidth wireless communication devices.

In one embodiment, a first Control Channel Element to Resource Element Group (CCE-REG) mapping is used for the CORESET when an aggregation level (AL) is greater than an AL threshold (Y) and, otherwise, a second CCE-REG mapping is used.

In one embodiment, a CCE-REG mapping for the CORESET is based on or derived from CCE-REG mappings for two or more CORESETs, wherein each of said two or more CORESETs comprises three or less Orthogonal Frequency Division Multiplexing (OFDM) symbols.

In another embodiment, a method performed by a wireless communication device for a cellular communications system comprises receiving, from a network node, information that configures a search space for the wireless communication device, the search space comprising four or more symbols in the time domain. The method further comprises receiving a PDCCH transmission from the network node within the search space.

In another embodiment, a method performed by a wireless communication device for a cellular communications system comprises receiving, from a network node, information that configures a CORESET #0 for the wireless communication device, deriving a new CORESET #0 for the wireless communication device based on a size of the configured CORESET #0 and a maximum supported bandwidth of the wireless communication device, and receiving a PDCCH transmission at the wireless communication device using the new CORESET #0. In this manner, the CORESET is enhanced in a way that is particularly beneficial for reduced bandwidth wireless communication devices.

In another embodiment, a method performed by wireless communication device for a cellular communications system comprises receiving, from a network node, information that configures a CORESET for the wireless communication device, wherein a CCE-REG mapping for the CORESET is based on or derived from CCE-REG mappings for two or more smaller CORESETs. The method further comprises receiving a PDCCH transmission from the network node within a search space that comprises at least a subset of time-frequency resources within the CORESET. In this manner, the CORESET is enhanced in a way that is particularly beneficial for reduced bandwidth wireless communication devices.

Corresponding embodiments of a wireless communication device are also disclosed.

Embodiments of a method performed by a network node for a cellular communications system are also disclosed. In one embodiment, a method performed by a network node for a cellular communications system comprises providing, to a wireless communication device, information that configures a CORESET for the wireless communication device, the CORESET comprising four or more symbols in the time domain.

In another embodiment, a method performed by a network node for a cellular communications system comprises providing, to a wireless communication device, information that configures a search space for the wireless communication device, the search space comprising four or more symbols in the time domain.

In another embodiment, a method performed by a network node for a cellular communications system comprises providing, to a wireless communication device, information that configures a CORESET #0 for the wireless communication device, deriving a new CORESET #0 for the wireless communication device based on a size of the configured CORESET #0 and a maximum supported bandwidth of the wireless communication device, and transmitting a PDCCH transmission to the wireless communication device using the new CORESET #0.

In another embodiment, a method performed by a network node for a cellular communications system comprises transmitting, to a wireless communication device, information that configures a CORESET for the wireless communication device, wherein a CCE-REG mapping for the CORESET is based on or derived from CCE-REG mappings for two or more smaller CORESETs. The method further comprises transmitting a PDCCH transmission to the wireless communication device within a search space that comprises at least a subset of time-frequency resources within the CORESET.

Corresponding embodiments of a network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a Control Resource Set (CORESET);

FIG. 2 illustrates one example of a cellular communications system in which embodiments of the present disclosure may be implemented;

FIG. 3 illustrates examples of interleaved and non-interleaved Control Channel Element (CCE) to Resource Element Group (REG) mappings for a CORESET;

FIG. 4 illustrates expansion of a CORESET in the time domain in accordance with one embodiment of the present disclosure;

FIG. 5 illustrates an example of an expanded CORESET in which REG boundaries are not aligned within the CORESET;

FIG. 6 illustrates the operation of a network node (e.g., a base station 202 or a network node that implements as least some of the functionality of a base station) and a wireless communication device (e.g., a User Equipment (UE)) to configure and use an expanded CORESET in accordance with one embodiment of the present disclosure;

FIG. 7 illustrates the structure of an example 4-symbol CORESET that is based on two concatenated 2-symbol CORESETs in accordance with an embodiment of the present disclosure;

FIG. 8 illustrates an example of an expanded CORESET where the expanded CORESET is a combination of K Release 15 CORESETs, each mapped to N consecutive symbols in each of K consecutive slots, in accordance with one embodiment of the present disclosure;

FIG. 9 illustrates an example of an expanded CORESET in which the expanded CORESET comprises K Release 15 CORESETs each taken from every Mth slot to create an N·K symbol CORESET spanning a time duration of M·K slots in accordance with an embodiment of the present disclosure;

FIG. 10 illustrates one example of a search space (SS) spread in time over a CORESET in accordance with one embodiment of the present disclosure;

FIG. 11 illustrates the operation of a network node (e.g., a base station or a network node that implements at least some of the functionality of a base station) and a wireless communication device (e.g., UE) to configure and use an expanded search space in accordance with one embodiment of the present disclosure;

FIG. 12 illustrates the operation of a network node (e.g., a base station 202 or a network node that implements at least some of the functionality of a base station) and a wireless communication device (e.g., UE) to configure and use a new CORESET #0 in accordance with one embodiment of the present disclosure;

FIGS. 13 through 15 are schematic block diagrams of example embodiments of a network node;

FIGS. 16 and 17 are schematic block diagrams of example embodiments of a wireless device;

FIG. 18 illustrates an example embodiment of a communication system in which embodiments of the present disclosure may be implemented;

FIG. 19 illustrates example embodiments of the host computer, base station, and UE of FIG. 18; and

FIGS. 20 through 23 are flow charts that illustrate example embodiments of methods implemented in a communication system such as that of FIG. 18.

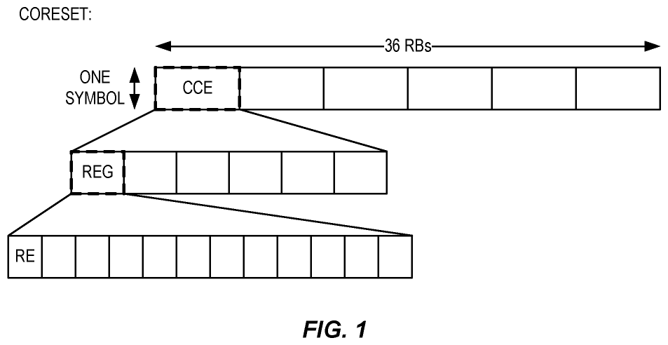

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There currently exist certain challenge(s). In NR, the Control Resource Set (CORESET) can be configured to occupy a very large bandwidth, e.g., up to the system bandwidth. This is beneficial if higher Aggregation Levels (ALs) are needed for UEs in bad coverage. The Physical Downlink Control Channel (PDCCH) can have enough capacity to send more Control Channel Elements (CCEs) in a larger bandwidth.

However, for reduced bandwidth UEs, due to limited bandwidth, they may not be able to be configured with high ALs (e.g., 8 or 16), which leads to PDCCH coverage degradation. Alternatively, due to the reduced bandwidth, the PDCCH capacity may not be large enough, e.g., the NR base station (gNB) may only be able to schedule one UE at a time for the high ALs.

For example, if the UE supports up to 10 Megahertz (MHz) bandwidth, the UE cannot be configured with AL 16 in the 30 kilohertz (kHz) subcarrier spacing (SCS) case by using the currently supported configurations. In the current design, CORESET duration can be at most three symbols, which is a limiting factor in supporting high ALs for reduced bandwidth UEs.

Certain aspects of the present disclosure and their embodiments may provide solutions to the aforementioned or other challenges. Systems and methods are proposed herein that provide CORESET enhancement for reduced bandwidth UEs. In one embodiment, by introducing the possibility of CORESET expansion in the time domain, high PDCCH ALs can be supported for reduced bandwidth UEs, which leads to coverage and capacity enhancement.

Certain embodiments may provide one or more of the following technical advantage(s). For example, the proposed time domain CORESET expansion allows the reduced bandwidth UEs to be configured with high PDCCH ALs to achieve high coverage and capacity.

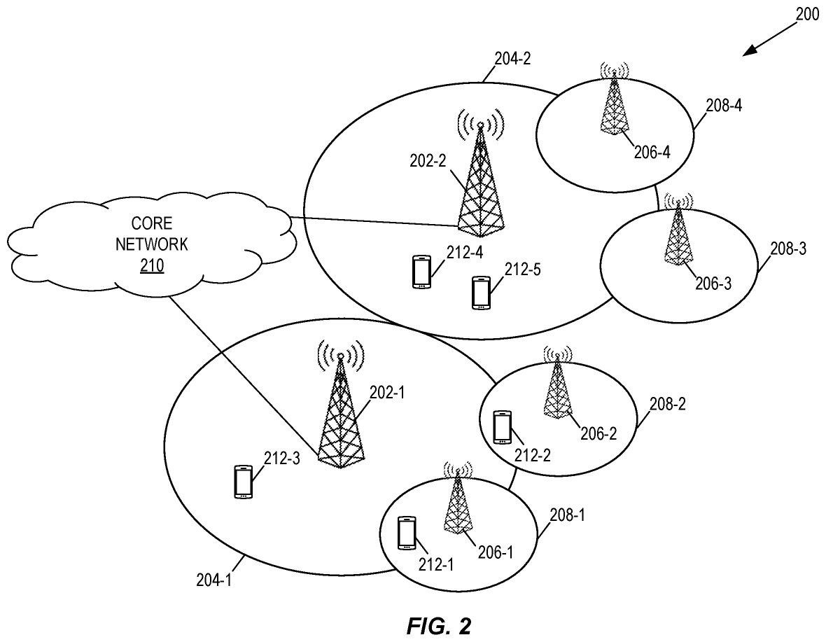

FIG. 2 illustrates one example of a cellular communications system 200 in which embodiments of the present disclosure may be implemented. In the embodiments described herein, the cellular communications system 200 is a 5G System (5GS) including a Next Generation Radio Access Network (NG-RAN); however, the embodiments disclosed herein are not limited thereto. In this example, the RAN includes base stations 202-1 and 202-2, which in the NG-RAN include NR base stations (gNBs) and optionally ng-eNBs (i.e., LTE RAN nodes connected to 5G Core (5GC)), controlling corresponding (macro) cells 204-1 and 204-2. The base stations 202-1 and 202-2 are generally referred to herein collectively as base stations 202 and individually as base station 202. Likewise, the (macro) cells 204-1 and 204-2 are generally referred to herein collectively as (macro) cells 204 and individually as (macro) cell 204. The RAN may also include a number of low power nodes 206-1 through 206-4 controlling corresponding small cells 208-1 through 208-4. The low power nodes 206-1 through 206-4 can be small base stations (such as pico or femto base stations) or Remote Radio Heads (RRHs), or the like. Notably, while not illustrated, one or more of the small cells 208-1 through 208-4 may alternatively be provided by the base stations 202. The low power nodes 206-1 through 206-4 are generally referred to herein collectively as low power nodes 206 and individually as low power node 206. Likewise, the small cells 208-1 through 208-4 are generally referred to herein collectively as small cells 208 and individually as small cell 208. The cellular communications system 200 also includes a core network 210, which in the 5GS is referred to as the 5G Core (5GC). The base stations 202 (and optionally the low power nodes 206) are connected to the core network 210.

The base stations 202 and the low power nodes 206 provide service to wireless communication devices 212-1 through 212-5 in the corresponding cells 204 and 208. The wireless communication devices 212-1 through 212-5 are generally referred to herein collectively as wireless communication devices 212 and individually as wireless communication device 212. In the following description, the wireless communication devices 212 are oftentimes UEs, but the present disclosure is not limited thereto.

Now, a description some example embodiments of the present disclosure will be provided. Currently, the NR system design mostly targets broadband services and assumes that all NR UEs can support large bandwidths, e.g., 100 Megahertz (MHz) in Frequency Range 1 (FR1). Therefore, the supported CORESETs can be configured to use almost all of the system bandwidth in the frequency domain and up to three Orthogonal Frequency Division Multiplexing (OFDM) symbols in the time domain. In a NR system with a large bandwidth, it is not a problem to support up to AL 16 and at the same time maintain the PDCCH capacity in a cell.

However, for NR-RedCap UEs which are expected to have much smaller bandwidth, as discussed above, both coverage problems due to not supporting high enough AL levels and capacity problems due to limited bandwidth may be encountered. These problems can be more prominent when the NR-RedCap UEs may not be able to perform as many blind decodings as NR UEs due to reduced complexity, meaning less PDCCH candidates are checked by the UEs to identify a Downlink Control Information (DCI).

One of the initial access steps is for the UE to acquire System Information Block type 1 (SIB1) (SIB1 is acquired after the UE acquires the Master Information Block (MIB)), which is scheduled through a PDCCH using Search Space #0 associated with CORESET #0. In NR, CORESET #0 has a bandwidth of 4.32 MHz, 8.64 MHz, or 17.28 MHz in FR1, and 34.56 MHz or 69.12 MHz in FR2. The bandwidth of CORESET #0 depends on the subcarrier spacing indicated in MIB (by parameter subCarnerSpacingCommon) and is configured by the network. If CORESET #0 uses 30 kilohertz (kHz) subcarrier spacing for PDCCH, the bandwidth of CORESET #0 can be either 8.64 MHz or 17.28 MHz. The network may choose either bandwidth option. Between the two options, some implementation considerations may favor the configuration of 17.28 MHz bandwidth for CORESET #0. For example, with 30 kHz subcarrier spacing and 17.28 MHz CORESET #0 bandwidth, a PDCCH can operate with AL 16, which offers the highest PDCCH coverage. In comparison, configuring CORESET #0 with bandwidth 8.64 MHz can only support AL 8 when PDCCH is configured with 30 kHz subcarrier spacing, which results in approximately 3 decibel (dB) coverage reduction compared to AL 16. Furthermore, using a higher CORESET #0 bandwidth gives rise to higher scheduling capacity. Using 17.28 MHz bandwidth, however, may result in CORESET #0 not being useable by low-complexity UEs, e.g., NR-RedCap UEs, that only support smaller UE bandwidths, especially considering that currently only an interleaved mapping is supported by CORESET #0, which means a PDCCH candidate may span the entire bandwidth of CORESET #0.

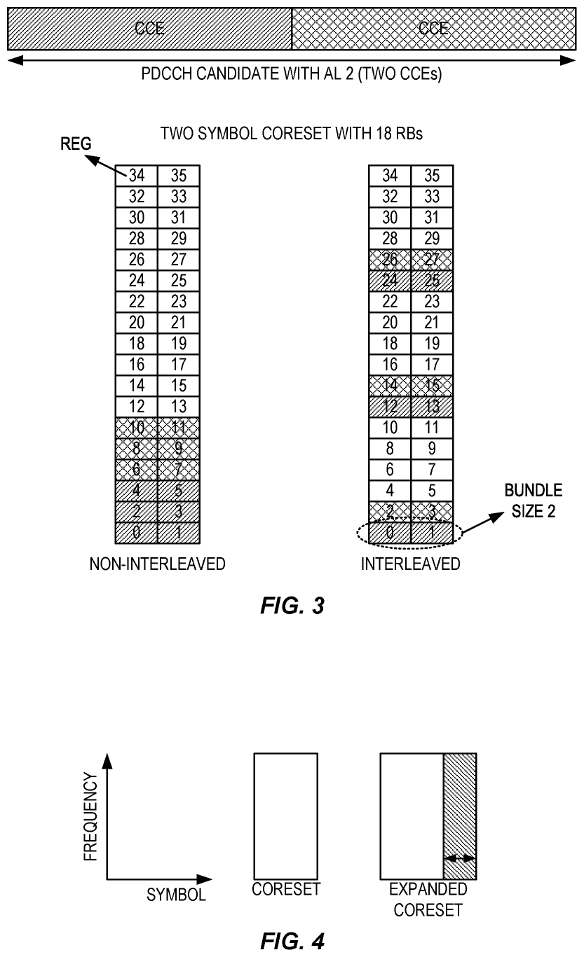

One solution to solve the problem as proposed herein is to expand the CORESET in the time domain, i.e., to include more than three OFDM symbols in the time domain. One associated challenge to this problem is that it may not be easy to support the current CCE mappings within a CORESET. Currently, a UE can be configured with multiple CORESETs. Each CORESET is associated with one CCE-to-REG mapping only. Both interleaved and non-interleaved mappings can be used. For a non-interleaved mapping, all CCEs for a DCI with AL L are mapped in consecutive REG bundles of the associated CORESET. For an interleaved mapping, each CCE may be split in frequency domain to provide diversity. Using AL 2 as an example, FIG. 3 illustrates the interleaved and non-interleaved cases.

For the interleaved case, the REG bundle size also has an impact on the mapping, where, within a REG bundle, the UE can assume the same precoding is used. In the frequency domain, other than CORESET #0, a bit map is used to indicate the resource allocation for the CORESETs. Each bit corresponds to a group of 6 RBs, with grouping starting from the first RB group (see, e.g., 3GPP TS 38.213, clause 10.1) in the bandwidth part (BWP). The first (left-most/most significant) bit corresponds to the first RB group in the BWP, and so on. A bit that is set to 1 indicates that this RB group belongs to the frequency domain resource of this CORESET. Bits corresponding to a group of RBs not fully contained in the BWP within which the CORESET is configured are set to zero (see, e.g., 3GPP TS 38.211, clause 7.3.2.2).

Therefore, it is not straight forward to simply add one or more OFDM symbols to the current CORESET configuration, since the granularity of a CCE is at least 6 REGs (6 RBs). This requires that the number of REGs in a CCE has to be a multiple of 6. This is not a problem, if one, two, or three OFDM symbols are used as these numbers are divisors of 6. However, this is not the case when 4 or 5 OFDMs are used. The mapping is not straight forward, as these numbers are not divisors of 6.

Several solutions are disclosed herein to design the CORESET and CCE-REG mappings to minimize the design changes based on the current NR design, when the CORESET is expanded in the time domain, for example to more than 3 OFDM symbols. Some embodiments described herein focus on providing solutions arising when an NR-RedCap device type is introduced, but the embodiments presented herein can be applied by any device type.

As discussed above, one way to support high ALs for reduced bandwidth UEs is to expand CORESETs in the time domain, as illustrated in FIG. 4. Specifically, the maximum duration of a CORESET is extended from 3 OFDM symbols to, for example, 4 OFDM symbols and/or OFDM 5 symbols. Clearly, the expanded CORESET has more CCEs compared to a regular CORESET and, hence, can support higher ALs. For example, for a CORESET with 24 RBs and 3 OFDM symbols, AL 16 cannot be supported. By expanding the CORESET duration to e.g., 4 OFDM symbols, AL 16 can be supported.

The expanded CORESET allows supporting high ALs for reduced bandwidth UEs and improves coverage and capacity of PDCCH. In Table 1 below, the maximum supported AL for three-symbol CORESETs and four-symbol CORESETs are presented. As can be seen from Table 1, it is beneficial to expand the CORESET duration to four OFDM symbols, particularly for CORESET sizes 12 RBs, 24 RBs, and 30 RBs.

TABLE 1
Maximum supported AL for three-symbol
CORESETs and four-symbol CORESETs.

| Number of RBs | Maximum AL for three- | Maximum AL for four- |
|---|---|---|
| in CORESET | symbol CORESET | symbol CORESET |
| 12 | 4 | 8 |
| 18 | 8 | 8 |
| 24 | 8 | 16 |
| 30 | 8 | 16 |
| 36 | 16 | 16 |

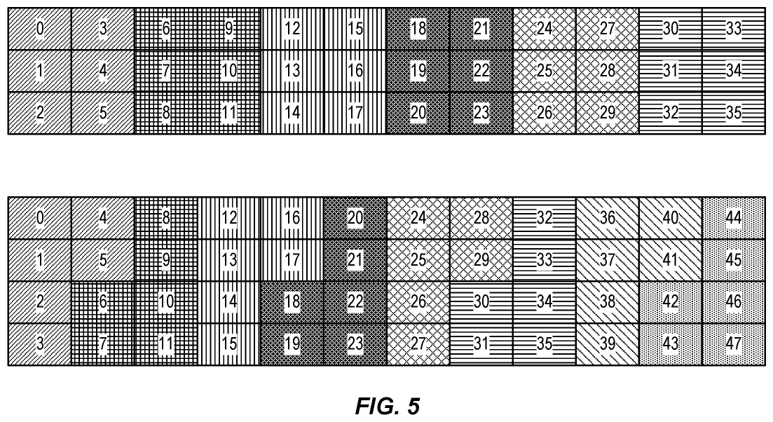

When the CORESET is expanded in time domain, it is desirable to keep a structure, when it comes to CCE-REG mappings, that is similar to that used in the legacy NR. In this way, a minimum amount of changes in the 3GPP NR specifications and UE implementation can be assumed. However, as 4 and 5 are not divisors of 6 (the number of REGs per CCE), if the same REG mapping principles as used in legacy NR are followed, the same alignment of the REG and CCE boundaries similar to the case of 1, 2 or 3 OFDM symbols may not be had. This raises a bigger problem when interleaved mapping is used when determining the REG bundle size. This is illustrated in FIG. 5. In particular, FIG. 5 illustrates an example in which REG boundaries are not aligned within a CORESET when 4 OFDM symbols are used.

With such mapping, as the CCE starting points vary in both time and frequency, it poses higher challenges for better alignment of the resources for multiplexing different UEs. Also, it is difficult to realize beamforming gains among different UEs. This is because, within one REG bundle, the UE can assume the same precoder is used, which provides beamforming gain to different UEs. However, if 4 OFDM symbols are used, for example in FIG. 5, RBs 4, 5, 6, and 7 would pose a problem if bundle size 6 is used. A larger bundle size reduces the possibilities to benefit from UE specific beamforming gains.

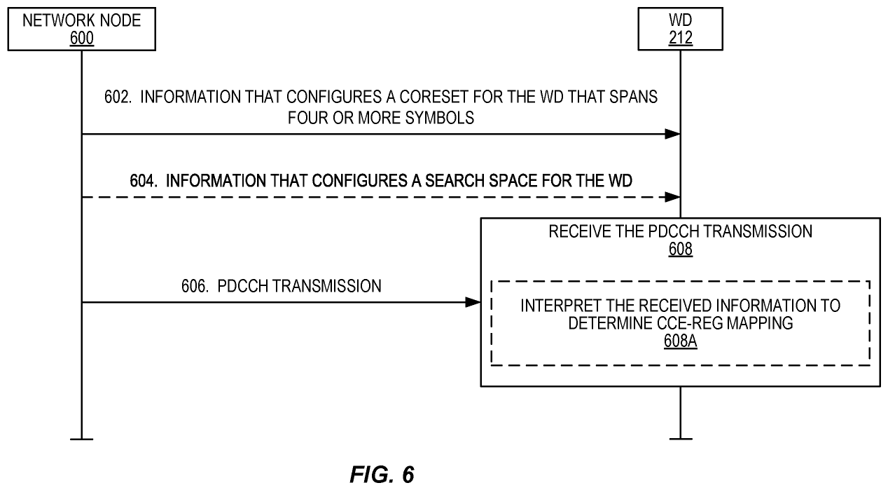

In this regard, FIG. 6 illustrates the operation of a network node 600 (e.g., a base station 202 or a network node that implements as least some of the functionality of a base station 202) and a wireless communication device 212 (e.g., UE) in accordance with at least some aspects of the expanded CORESET described herein. Optional steps are represented by dashed lines/boxes. As illustrated, the network node 600 provides, to the wireless communication device 212, information that configures a CORESET for the wireless communication device 212 (step 602). This CORESET is expanded in the time-domain such that the CORESET includes four or more symbols in the time-domain. The information provided to configure the CORESET for the wireless communication device 212 includes any information needed to configure the CORESET for the wireless communication device 212 in accordance with any of the expanded CORESET embodiments described herein. The network node 600 may also provide, to the wireless communication device 212, information that indicates a search space that includes time-frequency resources within the CORESET (step 604). The information that indicates the search space may include any information used to configure, e.g., a legacy search space (e.g., a Rel-15 search space) or an expanded search space as described herein. The network node 600 transmits a PDCCH transmission to the wireless communication device 212 within the CORESET and, more specifically, within the search space (step 606).

At the wireless communication device 212, the wireless communication device 212 receives the information that configures the CORESET for the wireless communication device in step 602, and optionally receives the information that indicates the search space in step 604. Based on the received information, the wireless communication device 212 receives the PDCCH transmission (step 608). More specifically, the wireless communication device 212 uses the information to determine PDCCH candidates to be monitored by the wireless communication device 212. As discussed below, in some embodiments, this includes interpreting the received information to determine the CCE-REG mapping (e.g., see solution below in which different mappings are used for different ranges of time-domain symbols in the CORESET and ALs) (step 608A).

Another problem here is how to coexist with the legacy NR CORESETs that are configured for legacy NR UEs on the same time/frequency resources. Therefore, the following solutions are proposed.

One solution is that when X OFDM symbols are configured for the CORESET (e.g., in step 602), the UE (e.g., the wireless communication device 212) can assume a new mapping for AL levels larger than Y when X>N symbols are used. For example, N may be equal to 3. To be more specific, if 4 OFDM symbols are configured for a CORESET (so X=4, N=3, and as such X>N), for AL less than or equal to a given level (say Y), the legacy mapping is assumed where the UE checks only up to the first 3 OFDM symbols (the 4th OFDM symbol is not used for AL levels less than or equal to Y). The legacy mapping is defined in 3GPP TS 38.211, Section 7.3.2. For AL levels higher than Y, additional OFDM symbol(s) are used, with a new CCE-REG mapping. Also, it is possible to configure the number of symbols and/or the AL levels for which legacy mapping applies. The AL threshold Y may vary depending on factors such as, e.g., the number of RBs used for the CORESET in the frequency domain. For example, looking at Table 1 above, for a CORESET with 24 RBs, the AL threshold (Y) may be 8. As another example, looking at Table 1 above, for a CORESET with 12 RBs, the AL threshold (Y) may be 4. Thus, in this solution, the wireless communication device 212 interprets the received information (in step 608A) to determine the appropriate CCE-REG mapping, where a different mapping is used when the AL is greater than Y and X>N as compared to the mapping that is otherwise used.

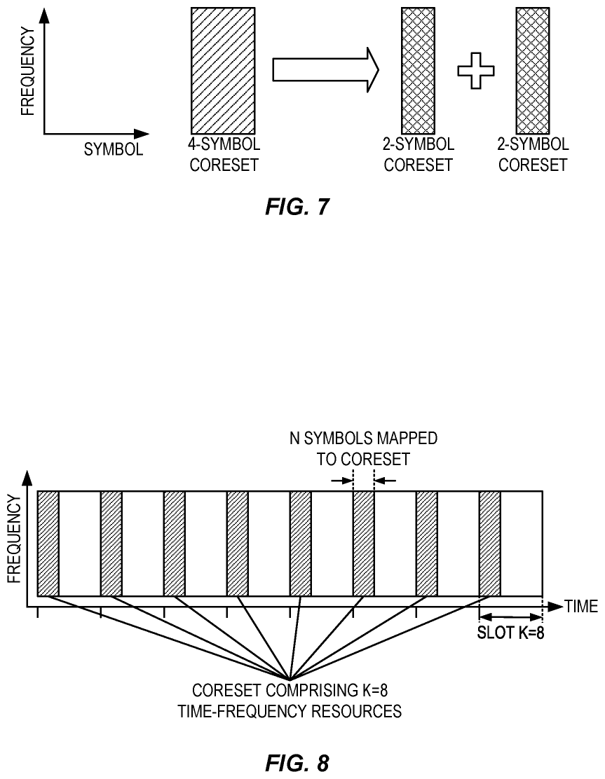

In another solution, the expanded CORESET (e.g., the CORESET configured in step 602 of FIG. 6) is based on or derived from CCE-REG mappings for two or more CORESETs, wherein each of the two or more CORESETs comprises 3 or less OFDM symbols. For example, in one embodiment, the expanded CORESET is a combination of two (or more) smaller CORESETs (e.g., a combination of two or more CORESETs each comprising 3 or less OFDM symbols). Note that the two or more CORESETs from which the expanded CORESET is derived or based on are each smaller than the expanded CORESET in the time domain (e.g., few number of symbols) but can be of the same size or a different size(s) than the expanded CORESET in the frequency domain (e.g., the number of RBS). As one example, a 4-symbol CORESET can be considered as two 2-symbol CORESETs. That is, the structure of the 4-symbol CORESET is based on two concatenated 2-symbol CORESETs, as shown in FIG. 7. In other words, FIG. 7 illustrates an example in which a 4-symbol CORESET is decomposed into two 2-symbol CORESETs. In this case, structure of the 4-symbol CORESET is determined based on the structure and parameters (e.g., CCE indexes, bundle size, CCE-REG interleaving, etc.) of two 2-symbol CORESETS. For example, AL is defined as the total number of used CCEs within the CORESET occupying time-frequency resources. Therefore, the AL of the expanded CORESET is the sum of ALs of the smaller CORESETs. First, without considering AL, the 4-symbol CORESET is split into two 2-symbol CORESETs, and the CCEs within each CORESET (say e.g., 1-10 in each) are indexed. Then, the CCE-REG mapping (with the same parameters) is applied to both 2-symbol CORESETs. Now, the time-frequency resources occupied by each CCE is known. It is also possible to have other combination, e.g., 1+3 or 3+1. Additionally, we can also configure the AL level mappings based on the CORESET combination. That is, if 2+2 symbols are used, the REG mapping within each two symbols are the same as legacy. We will have additional rules to combine the legacy REG mappings to achieve a higher AL level.

In addition, several other enhancements can be considered for CORESET and search space configurations.

In one embodiment, multiple time-frequency resources spread in time define a CORESET (e.g., the CORESET of step 602 of FIG. 6). In one example, K Release 15 CORESETs, each mapped to N consecutive symbols in each of K consecutive slots, are combined into a K·N symbol CORESET spanning a time duration of K slots. This example is illustrated in FIG. 8. In other words, the CORESET (e.g., the CORESET of step 602 of FIG. 6) is a combination of K Release 15 CORESETs, each mapped to N consecutive symbols in each of K consecutive slots.

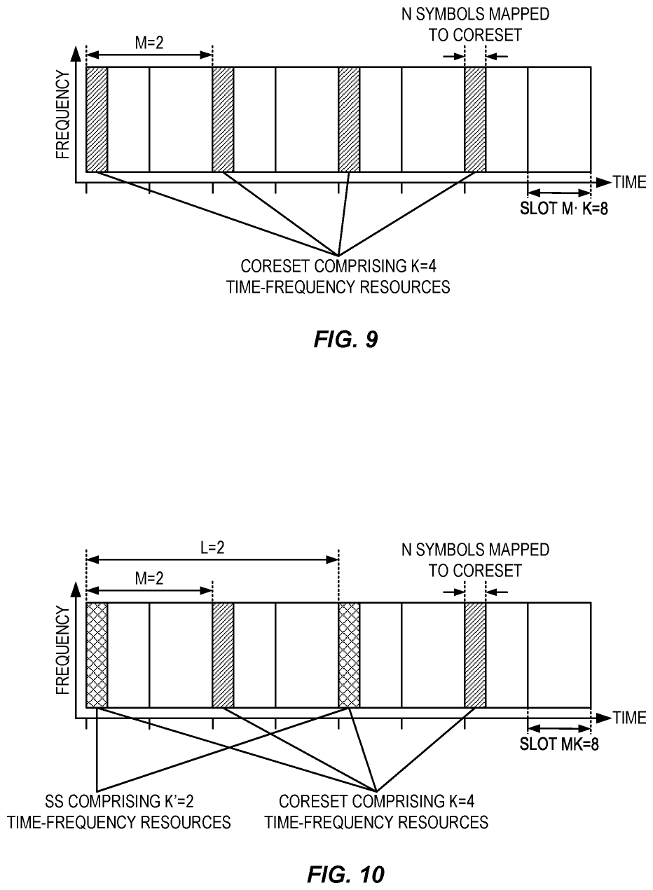

In yet another example, the new CORESET (e.g., the CORESET of step 602 of FIG. 6) comprises K Rel-15 CORESETs each taken from every Mth slot to create an N·K symbol CORESET spanning a time duration of M·K slots. This is illustrated in FIG. 9. In particular, FIG. 9 illustrates an example CORESET spread in time on non-consecutive slots with M=2.

Note that, although the above examples of FIGS. 8 and 9 illustrate N adjacent symbols within a slot, the N symbols may alternatively be spread over the 14 symbols in a slot. In other words, the N symbols within a particular slot may be any N symbols within that slot.

Embodiments described herein for constructing expanded CORESETs (e.g., the CORESET of step 602 of FIG. 6) can be combined and varied in several ways. In one embodiment, an expanded CORESET (e.g., the CORESET of step 602 of FIG. 6) is constructed from multiple time-frequency resources within the same slot.

In one embodiment, each of the time-frequency resources constitute a CORESET of its own, such as an NR Rel-15 CORESET.

An expanded CORESET (e.g., the CORESET of step 602 of FIG. 6) may also consist of time-frequency resources that occur in more irregular patterns. In one such embodiment, the time-frequency resources contained in an expanded CORESET (e.g., the CORESET of step 602 of FIG. 6) is indicated by a bitmap, where each bit represents a time-frequency resource, for example one CORESET in one slot. A bit set to 1 indicates that the corresponding time-frequency resource is included in the expanded CORESET. In other embodiments, the time-frequency resources are indexed, and the resources to include are indicated by one or more of a formula, a look-up table, or a list of indexes, or are otherwise explicitly or implicitly defined.

In one embodiment, a first set of resources to include in a CORESET (e.g., the CORESET of step 602 of FIG. 6) is indicated in terms of one or more of the embodiments mentioned herein, and a subset of this first set is excluded from inclusion in the CORESET. This subset may also be indicated in terms of one or more of the embodiments mentioned herein. One scenario in which this exclusion can be useful is when certain CORESETs are reserved for use only on their own, and not for use in an expanded CORESET. Without limitation, this can be used when legacy devices are configured to monitor PDCCH in a CORESET for common control messages for, e.g., paging, random access, or system information, whereas NR-RedCap UEs are restricted from using this CORESET.

As explained above, one purpose of introducing CORESETs expanded in time domain is to enable higher PDCCH aggregation levels than would otherwise be possible using the number of resource elements available in a Rel-15 CORESET, in particular given the reduced bandwidth of an NR-RedCap UE. However, in alternative embodiments, a control message in a PDCCH transmission is encoded using a lower aggregation level but is instead included in the CORESET (e.g., the CORESET of step 602 of FIG. 6) using two or more repetitions of the same control message. These repetitions may use identical bits as for the original encoded message, or use some alternative encoding, such as different scrambling codes, different redundancy versions, or other techniques known in the art.

In NR Rel-15, a search space is defined as a number of PDCCH candidates located within a CORESET that a UE is configured to monitor. Similarly, an expanded CORESET as described herein may be used for defining a search space within which an NR-RedCap UE, or any other UE, may be configured to monitor PDCCH candidates.

Similar to the construction of expanded CORESETs, an expanded search space (e.g., the search space of step 604 of FIG. 6) can be constructed based on combinations of time-frequency resources, within which a UE is monitoring a number of PDCCH candidates.

In one such embodiment, an expanded search space (e.g., the search space of step 604 of FIG. 6) is defined to comprise every L'th time-frequency resources of a CORESET (e.g., the CORESET of step 602 of FIG. 6), where L>=1. In total, K″>1 time-frequency resources are included in the search space. One example of this embodiment is illustrated in FIG. 10. In other words, FIG. 10 illustrates one example of a search space (SS) spread in time over a CORESET.

More generally, the methods and embodiments described above for constructing CORESETs expanded in time domain may additionally or alternatively be used for constructing a search space expanded in time domain. The definition of the expanded search space may be expressed in terms of general time-frequency resources, Rel-15 CORESETS, expanded CORESETs as disclosed herein, or Rel-15 search spaces, or any combination thereof. Thus, it is to be understood that the expanded search space aspects described herein may be used in combination with the expanded CORESET aspects or may be used independently from the expanded CORESET aspects described herein.

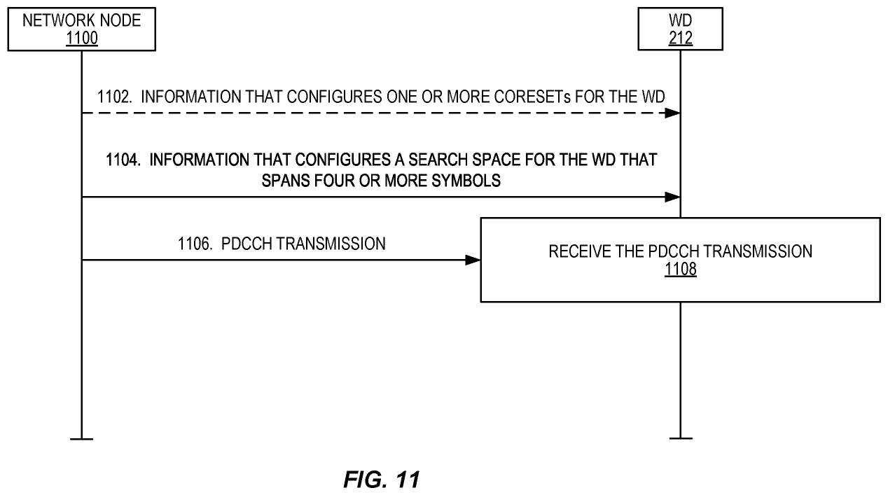

In this regard, FIG. 11 illustrates the operation of a network node 1100 (e.g., a base station 202 or a network node that implements at least some of the functionality of a base station 202) and a wireless communication device 212 (e.g., UE) in accordance with at least some aspects of the expanded search space described herein. Optional steps are represented by dashed lines/boxes. As illustrated, the network node 1100 may provide, to the wireless communication device 212, information that configures one or more CORESETs for the wireless communication device 212 (step 1102). For example, each of the configured CORESETs may be expanded in the time-domain such that the CORESET includes four or more symbols in the time-domain or may be a conventional CORESET (e.g., a Rel-15 CORESET). The information provided to configure each CORESET for the wireless communication device 212 includes any information needed to configure the CORESET for the wireless communication device 212 in accordance with any of expanded CORESET embodiments described herein or information used to configure a conventional CORESET (e.g., a Release 15 CORESET). The network node 1100 provides, to the wireless communication device 212, information that indicates a search space that includes time-frequency resources within four or more symbols (step 1104). In this regard, the search space may be an extended search space in accordance with any of the expanded search space embodiments described herein. The configured search space includes time-frequency resources in at least one, but possibly more than one, of the configured CORESETs. The information provided to configure the search space for the wireless communication device 212 includes any information needed to configure the search space for the wireless communication device 212 in accordance with any of expanded search space embodiments described herein. The network node 1100 transmits a PDCCH transmission to the wireless communication device 212 within the search space (step 1106).

At the wireless communication device 212, the wireless communication device 212 optionally receives the information that configures the one or more CORESETs for the wireless communication device in step 1102, receives the information that indicates the search space in step 1104, and uses the received information to receive the PDCCH transmission (step 1108).

In one embodiment, when a PDCCH transmission (e.g. the PDCCH transmission of step 1106 of FIG. 11) includes (e.g., consists of) N repetitions, each PDCCH repetition is mapped to one Rel-15 (or expanded) CORESET (e.g., mapped to one of the CORESETs configured in step 1102 of FIG. 11), and the expanded search space (e.g., the search space of step 1104 of FIG. 11) includes (e.g., consists of) time-frequency resources from Msuch CORESETs, where M>=/V. In other embodiments, two or more PDCCH repetitions are mapped to one Rel-15 (or expanded) CORESET. In yet other embodiments, each PDCCH repetition is mapped to two or more Rel-15 (or expanded) CORESETs.

In NR Rel-15, a PDCCH candidate using a certain aggregation level AL uses a set of CCEs determined by a hash function. In one embodiment, a PDCCH transmission (e.g., the PDCCH transmission of step 1106 of FIG. 11) includes (e.g., consists of) N repetitions, where each repetition uses the same set of CCEs. In another embodiment, the set of CCEs to use is determined individually for each repetition.

In one embodiment, when an expanded search space (e.g., the search space of step 1104 of FIG. 11) includes time-frequency resources from M CORESETs, a PDCCH transmission in the search space may include (e.g., consist of) N repetitions, where Nis any number in a subset of integers with N<=M. A specific PDCCH (e.g., the PDCCH transmission of step 1106 of FIG. 11) may, in general, may be mapped to any subset of N CORESETs within the M CORESETs in the search space. In other words, the N repetitions may be mapped to N CORESETs within the M CORESETs, where these N CORESETs are any subset of N CORESETs from among the M CORESETs. In some embodiments, the possible subsets of N CORESETs are restricted to have certain starting positions. In one such embodiment, a PDCCH transmission consisting of N transmissions may start in any CORESET numbered nN in the search space, where n is a non-negative integer such that (n−1)N<=M.

Different types of encoding can be applied for the PDCCH (e.g., the PDCCH transmission of step 606 or 1106) mapped on the CORESET and/or search space. Repetition encoding, where parts on the symbols mapped on a first time-frequency resource is repeated on later resources, can be used to improve performance for a time-invariant radio channel. Alternatively, the encoded bits, or symbols can be time-interleaved over the coreset and/or search space to improve performance for a time-variant radio channel.

An expanded search space, or an expanded CORESET, as disclosed herein, may be defined to occur with a certain periodicity P. If, for example, an expanded search space extends over M slots, the periodicity may be expressed as a number of slots P>=M. The starting position of a search space may, for example, be expressed in terms of the first slot of the first CORESET. The starting position may be a function of, e.g., the system frame number (SFN), a subframe number, and/or a slot number.

Different embodiments disclosed herein involve parameters, bitmaps, formulas, functions, lists, etc., some of which have mentioned explicitly above. These entities may be defined in different ways, including written in standards documents, or through Radio Resource Control (RRC) signaling, or combinations thereof. RRC signaling may be broadcast via system information or unicast via UE-specific signaling. Without limitation, the entities may be introduced as additions or extensions to relevant current definitions in TS 38.331, e.g., the information elements SearchSpace, ControlResourceSet, PDCCH-Config, and/or PDCCH-ConfigCommon.

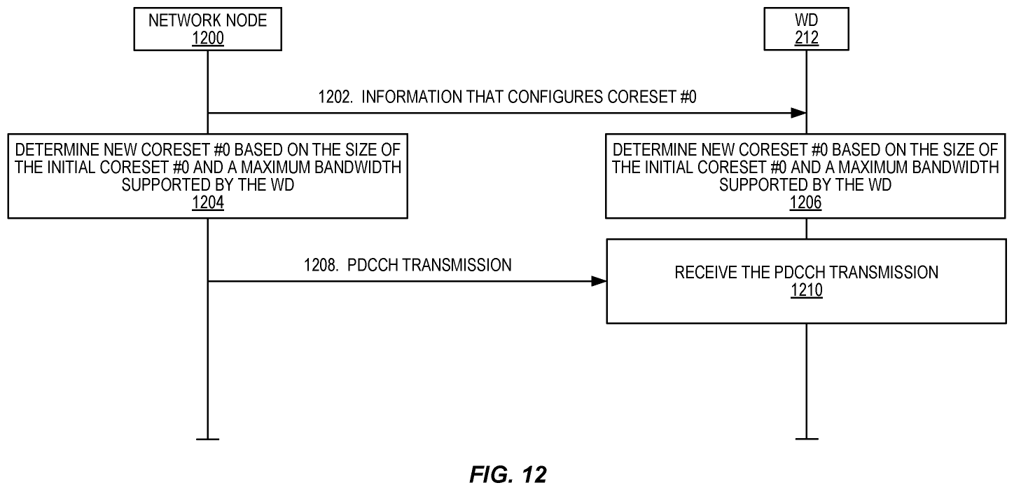

Yet another solution for CORESET expansion to derive a new CORESET #0 for NR-Redcap UEs from the CORESET #0 provided by MIB based on the size of the CORESET #0 provided by MIB and the maximum supported bandwidth of the NR-Redcap UE. FIG. 12 illustrates the operation of a network node 1200 (e.g., a base station 202 or a network node that implements at least some of the functionality of a base station 202) and a wireless communication device 212 (e.g., UE) in accordance with at least some aspects described herein. Optional steps are represented by dashed lines/boxes. As illustrated, the network node 1200 may provide, to the wireless communication device 212, information that configures a CORESET #0 (e.g., in MIB) for the wireless communication device 212 (step 1202). Both the network node 1200 and the wireless communication device 212 derive a new CORESET #0 for the wireless communication device 212 based on the size of the CORESET #0 configured in step 1202 and a maximum supported bandwidth of the wireless communication device 212 (steps 1204 and 1206). Note that the maximum bandwidth supported by the wireless communication device 212 may, for example, be reported by the wireless communication device 212 or be implied from other information reported by the wireless communication device 212 (e.g., a device type). Note, however, that these are only examples. The network node 1200 may obtain the maximum supported bandwidth of the wireless communication device 212 using any desired mechanism. The network node transmits, and the wireless communication device 212 receives, a PDCCH transmission in the new CORESET #0 (steps 1208 and 1210).

The frequency-domain resource of the CORESET #0 used for NR-Redcap UE, N′rb is derived as a maximum value in a set, e.g., {12, 24, 48, 96} such that it is smaller or equal to the frequency domain resources (in PRBs) of CORESET #0 provided by MIB, say Nrb, and the maximum supported bandwidth of the NR-Redcap UE.

The time domain resource of CORESET #0 used for NR-Redcap UE can be increased from the duration of CORESET #0 provided by MIB (Nsym=1,2,3 symbols) to N′sym where N′sym is the maximum integer such that N′rb*N′sym<=Nrb*Nsym. This expansion in time domain from Nsym to N′sym is to potentially compensate for the smaller N′rb of the derived CORESET #0 of the NR-Redcap UE.

In one version of the above solution, the expansion is allowed only up to N′sym=3 symbols.

Based on the above solution, the CCE-to-REG mapping for the derived CORESET #0 for NR-Redcap UE can follow the same formula as in NR Rel-15 with L=6 and R=2 where the parameter N_{REG}^{CORESET} is replaced by N′_{REG}^{CORESET}. N′rb*N′sym (see Section 7.3.2.2 in TS 38.211). Similarly, the CCE indices of PDCCH candidates in search space #0 associated with the derived CORESET #0 for NR-Redcap UE can be determined in the same way as in NR-Rel-15, i.e., the same hash function (see Section 10.1 in TS 38.213) by replacing N_{CCE,0} by N′_{CCE,0}=N′rb*N′sym/6.

To determine PDCCH monitoring occasions/search space #0 associated with CORESET #0 for NR-Redcap UE, there can be additional information for time offset (e.g., in slot-level or symbol-level) relative to the search space #0 provided by MIB. This information can be fixed in the specification or configured, e.g., by a spare bit in MIB or indicated through some bit carried in PBCH.

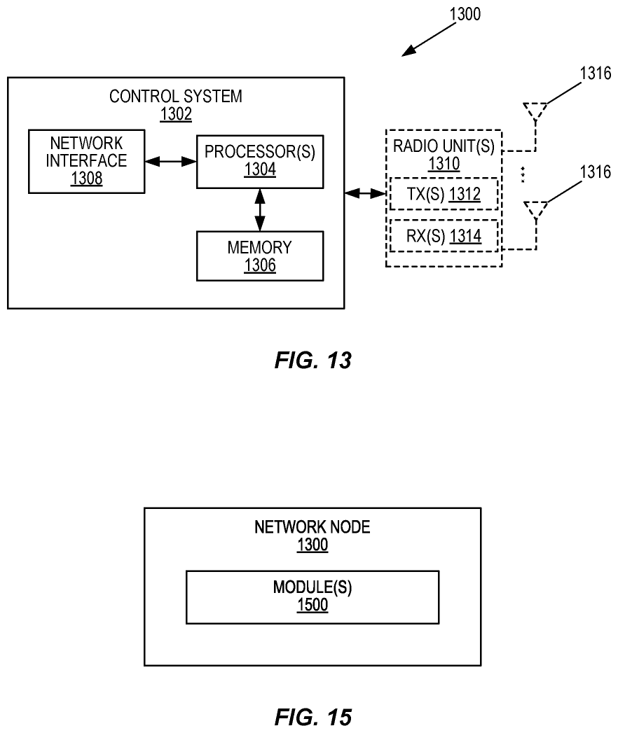

FIG. 13 is a schematic block diagram of a network node 1300 according to some embodiments of the present disclosure. Optional features are represented by dashed boxes. The network node 1300 may be, for example, the network node 600, 1100, or 1200 such as, e.g., a base station 202 or 206 or a network node that implements all or part of the functionality of the network node, base station 202, or gNB described herein. As illustrated, the network node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the network node 1300 may include one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of the network node 1300 as described herein (e.g., one or more functions of the network node 600, 1100, 1200 or base station 202 described herein). In some embodiments, the function(s) are implemented in software that is stored, e.g., in the memory 1306 and executed by the one or more processors 1304.

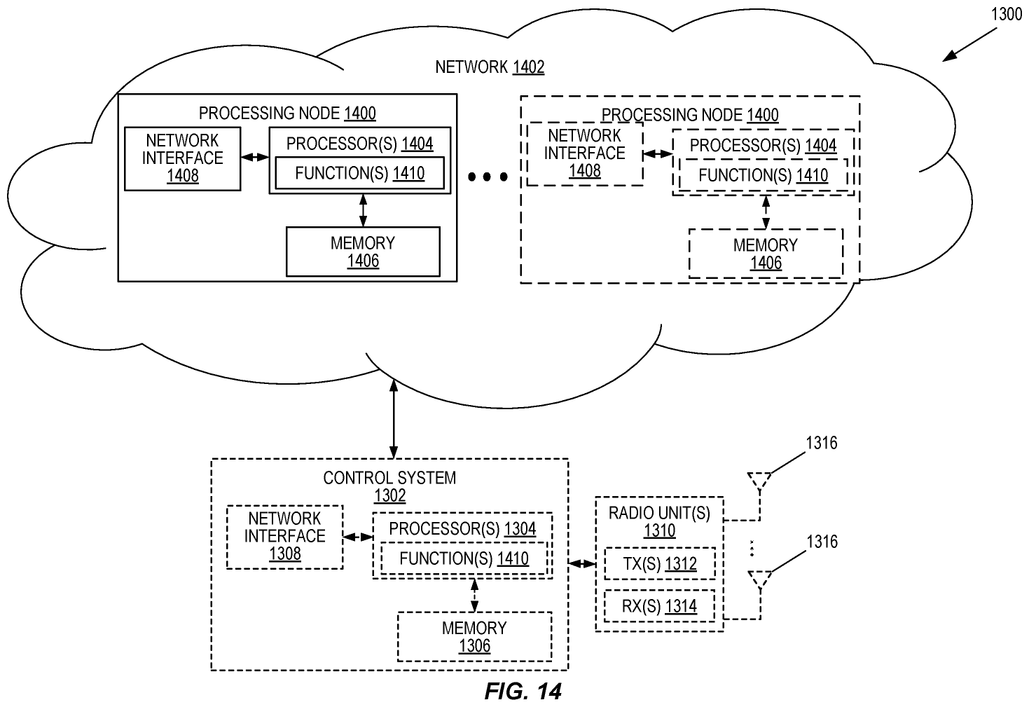

FIG. 14 is a schematic block diagram that illustrates a virtualized embodiment of the network node 1300 according to some embodiments of the present disclosure. This discussion is equally applicable to other types of network nodes. Further, other types of network nodes may have similar virtualized architectures. Again, optional features are represented by dashed boxes.

As used herein, a “virtualized” network node is an implementation of the network node 1300 in which at least a portion of the functionality of the network node 1300 is implemented as a virtual component(s) (e.g., via a virtual machine(s) executing on a physical processing node(s) in a network(s)). As illustrated, in this example, the radio access node 1300 may include the control system 1302 and/or the one or more radio units 1310, as described above. The control system 1302 may be connected to the radio unit(s) 1310 via, for example, an optical cable or the like. The network node 1300 includes one or more processing nodes 1400 coupled to or included as part of a network(s) 1402. If present, the control system 1302 or the radio unit(s) are connected to the processing node(s) 1400 via the network 1402. Each processing node 1400 includes one or more processors 1404 (e.g., CPUs, ASICs, FPGAs, and/or the like), memory 1406, and a network interface 1408.

In this example, functions 1410 of the network node 1300 described herein (e.g., one or more functions of the network node 600, 1100, 1200 or base station 202 described herein) are implemented at the one or more processing nodes 1400 or distributed across the one or more processing nodes 1400 and the control system 1302 and/or the radio unit(s) 1310 in any desired manner. In some particular embodiments, some or all of the functions 1410 of the network node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of the network node 1300 or a node (e.g., a processing node 1400) implementing one or more of the functions 1410 of the network node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the network node 1300 according to some other embodiments of the present disclosure. The radio access node 1300 includes one or more modules 1500, each of which is implemented in software. The module(s) 1500 provide the functionality of the radio access node 1300 described herein (e.g., one or more functions of the network node 600, 1100, 1200 or base station 202 described herein). This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

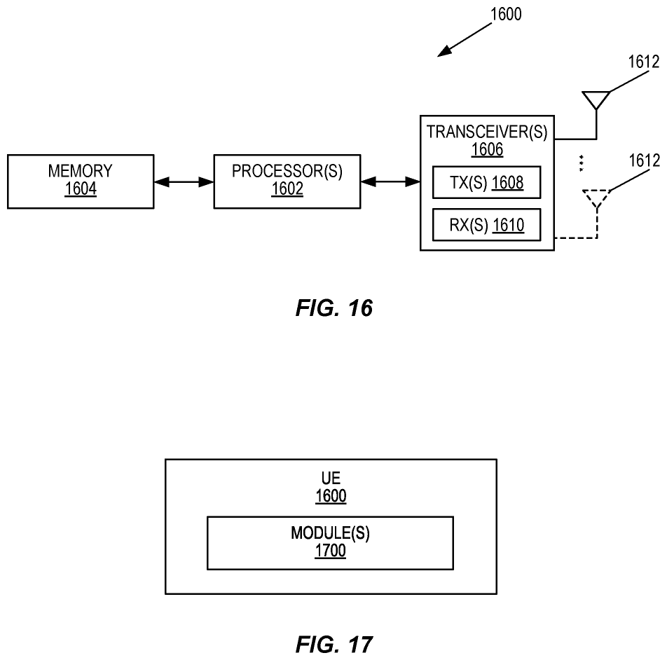

FIG. 16 is a schematic block diagram of a wireless communication device 1600 (e.g., the wireless communication device 212 or UE described above) according to some embodiments of the present disclosure. As illustrated, the wireless communication device 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the wireless communication device 1600 described above (e.g., one or more functions of the wireless communication device 212 or UE described herein) may be fully or partially implemented in software that is, e.g., stored in the memory 1604 and executed by the processor(s) 1602. Note that the wireless communication device 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the wireless communication device 1600 and/or allowing output of information from the wireless communication device 1600), a power supply (e.g., a battery and associated power circuitry), etc.

In some embodiments, a computer program including instructions which, when executed by at least one processor, causes the at least one processor to carry out the functionality of the wireless communication device 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the wireless communication device 1600 according to some other embodiments of the present disclosure. The wireless communication device 1600 includes one or more modules 1700, each of which is implemented in software. The module(s) 1700 provide the functionality of the wireless communication device 1600 described herein (e.g., one or more functions of the wireless communication device 212 or UE described herein).

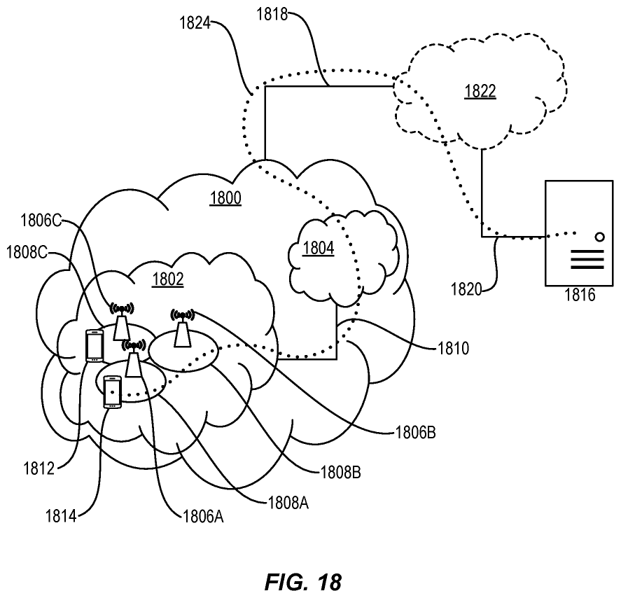

With reference to FIG. 18, in accordance with an embodiment, a communication system includes a telecommunication network 1800, such as a 3GPP-type cellular network, which comprises an access network 1802, such as a RAN, and a core network 1804. The access network 1802 comprises a plurality of base stations 1806A, 1806B, 1806C, such as Node Bs, eNBs, gNBs, or other types of wireless Access Points (APs), each defining a corresponding coverage area 1808A, 1808B, 1808C. Each base station 1806A, 1806B, 1806C is connectable to the core network 1804 over a wired or wireless connection 1810. A first UE 1812 located in coverage area 1808C is configured to wirelessly connect to, or be paged by, the corresponding base station 1806C. A second UE 1814 in coverage area 1808A is wirelessly connectable to the corresponding base station 1806A. While a plurality of UEs 1812, 1814 are illustrated in this example, the disclosed embodiments are equally applicable to a situation where a sole UE is in the coverage area or where a sole UE is connecting to the corresponding base station 1806.

The telecommunication network 1800 is itself connected to a host computer 1816, which may be embodied in the hardware and/or software of a standalone server, a cloud-implemented server, a distributed server, or as processing resources in a server farm. The host computer 1816 may be under the ownership or control of a service provider, or may be operated by the service provider or on behalf of the service provider. Connections 1818 and 1820 between the telecommunication network 1800 and the host computer 1816 may extend directly from the core network 1804 to the host computer 1816 or may go via an optional intermediate network 1822. The intermediate network 1822 may be one of, or a combination of more than one of, a public, private, or hosted network; the intermediate network 1822, if any, may be a backbone network or the Internet; in particular, the intermediate network 1822 may comprise two or more sub-networks (not shown).

The communication system of FIG. 18 as a whole enables connectivity between the connected UEs 1812, 1814 and the host computer 1816. The connectivity may be described as an Over-the-Top (OTT) connection 1824. The host computer 1816 and the connected UEs 1812, 1814 are configured to communicate data and/or signaling via the OTT connection 1824, using the access network 1802, the core network 1804, any intermediate network 1822, and possible further infrastructure (not shown) as intermediaries. The OTT connection 1824 may be transparent in the sense that the participating communication devices through which the OTT connection 1824 passes are unaware of routing of uplink and downlink communications. For example, the base station 1806 may not or need not be informed about the past routing of an incoming downlink communication with data originating from the host computer 1816 to be forwarded (e.g., handed over) to a connected UE 1812. Similarly, the base station 1806 need not be aware of the future routing of an outgoing uplink communication originating from the UE 1812 towards the host computer 1816.

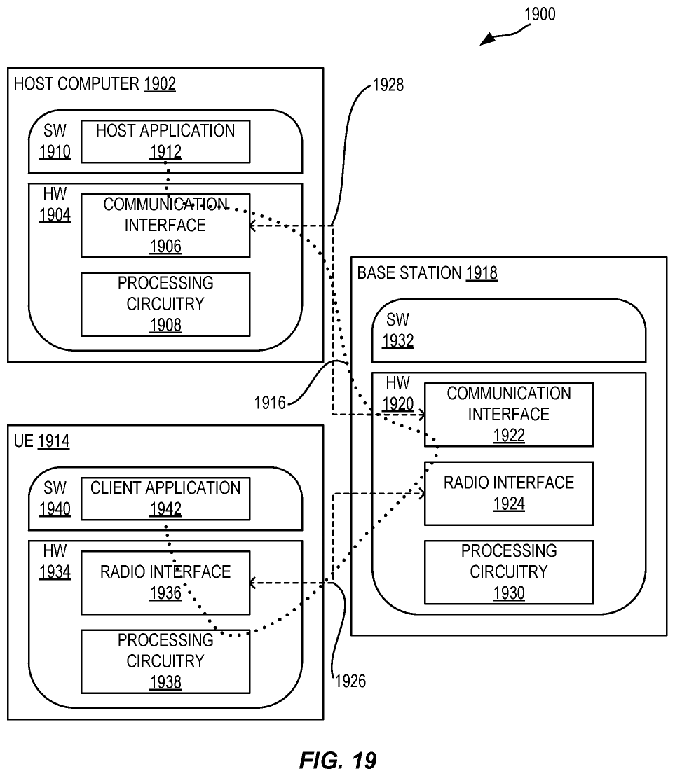

Example implementations, in accordance with an embodiment, of the UE, base station, and host computer discussed in the preceding paragraphs will now be described with reference to FIG. 19. In a communication system 1900, a host computer 1902 comprises hardware 1904 including a communication interface 1906 configured to set up and maintain a wired or wireless connection with an interface of a different communication device of the communication system 1900. The host computer 1902 further comprises processing circuitry 1908, which may have storage and/or processing capabilities. In particular, the processing circuitry 1908 may comprise one or more programmable processors, ASICs, FPGAs, or combinations of these (not shown) adapted to execute instructions. The host computer 1902 further comprises software 1910, which is stored in or accessible by the host computer 1902 and executable by the processing circuitry 1908. The software 1910 includes a host application 1912. The host application 1912 may be operable to provide a service to a remote user, such as a UE 1914 connecting via an OTT connection 1916 terminating at the UE 1914 and the host computer 1902. In providing the service to the remote user, the host application 1912 may provide user data which is transmitted using the OTT connection 1916.

The communication system 1900 further includes a base station 1918 provided in a telecommunication system and comprising hardware 1920 enabling it to communicate with the host computer 1902 and with the UE 1914. The hardware 1920 may include a communication interface 1922 for setting up and maintaining a wired or wireless connection with an interface of a different communication device of the communication system 1900, as well as a radio interface 1924 for setting up and maintaining at least a wireless connection 1926 with the UE 1914 located in a coverage area (not shown in FIG. 19) served by the base station 1918. The communication interface 1922 may be configured to facilitate a connection 1928 to the host computer 1902. The connection 1928 may be direct or it may pass through a core network (not shown in FIG. 19) of the telecommunication system and/or through one or more intermediate networks outside the telecommunication system. In the embodiment shown, the hardware 1920 of the base station 1918 further includes processing circuitry 1930, which may comprise one or more programmable processors, ASICs, FPGAs, or combinations of these (not shown) adapted to execute instructions. The base station 1918 further has software 1932 stored internally or accessible via an external connection.

The communication system 1900 further includes the UE 1914 already referred to. The UE's 1914 hardware 1934 may include a radio interface 1936 configured to set up and maintain a wireless connection 1926 with a base station serving a coverage area in which the UE 1914 is currently located. The hardware 1934 of the UE 1914 further includes processing circuitry 1938, which may comprise one or more programmable processors, ASICs, FPGAs, or combinations of these (not shown) adapted to execute instructions. The UE 1914 further comprises software 1940, which is stored in or accessible by the UE 1914 and executable by the processing circuitry 1938. The software 1940 includes a client application 1942. The client application 1942 may be operable to provide a service to a human or non-human user via the UE 1914, with the support of the host computer 1902. In the host computer 1902, the executing host application 1912 may communicate with the executing client application 1942 via the OTT connection 1916 terminating at the UE 1914 and the host computer 1902. In providing the service to the user, the client application 1942 may receive request data from the host application 1912 and provide user data in response to the request data. The OTT connection 1916 may transfer both the request data and the user data. The client application 1942 may interact with the user to generate the user data that it provides.

It is noted that the host computer 1902, the base station 1918, and the UE 1914 illustrated in FIG. 19 may be similar or identical to the host computer 1816, one of the base stations 1806A, 1806B, 1806C, and one of the UEs 1812, 1814 of FIG. 18, respectively. This is to say, the inner workings of these entities may be as shown in FIG. 19 and independently, the surrounding network topology may be that of FIG. 18.

In FIG. 19, the OTT connection 1916 has been drawn abstractly to illustrate the communication between the host computer 1902 and the UE 1914 via the base station 1918 without explicit reference to any intermediary devices and the precise routing of messages via these devices. The network infrastructure may determine the routing, which may be configured to hide from the UE 1914 or from the service provider operating the host computer 1902, or both. While the OTT connection 1916 is active, the network infrastructure may further take decisions by which it dynamically changes the routing (e.g., on the basis of load balancing consideration or reconfiguration of the network).

The wireless connection 1926 between the UE 1914 and the base station 1918 is in accordance with the teachings of the embodiments described throughout this disclosure. One or more of the various embodiments improve the performance of OTT services provided to the UE 1914 using the OTT connection 1916, in which the wireless connection 1926 forms the last segment.

A measurement procedure may be provided for the purpose of monitoring data rate, latency, and other factors on which the one or more embodiments improve. There may further be an optional network functionality for reconfiguring the OTT connection 1916 between the host computer 1902 and the UE 1914, in response to variations in the measurement results. The measurement procedure and/or the network functionality for reconfiguring the OTT connection 1916 may be implemented in the software 1910 and the hardware 1904 of the host computer 1902 or in the software 1940 and the hardware 1934 of the UE 1914, or both. In some embodiments, sensors (not shown) may be deployed in or in association with communication devices through which the OTT connection 1916 passes; the sensors may participate in the measurement procedure by supplying values of the monitored quantities exemplified above, or supplying values of other physical quantities from which the software 1910, 1940 may compute or estimate the monitored quantities. The reconfiguring of the OTT connection 1916 may include message format, retransmission settings, preferred routing, etc.; the reconfiguring need not affect the base station 1918, and it may be unknown or imperceptible to the base station 1918. Such procedures and functionalities may be known and practiced in the art. In certain embodiments, measurements may involve proprietary UE signaling facilitating the host computer 1902's measurements of throughput, propagation times, latency, and the like. The measurements may be implemented in that the software 1910 and 1940 causes messages to be transmitted, in particular empty or ‘dummy’ messages, using the OTT connection 1916 while it monitors propagation times, errors, etc.

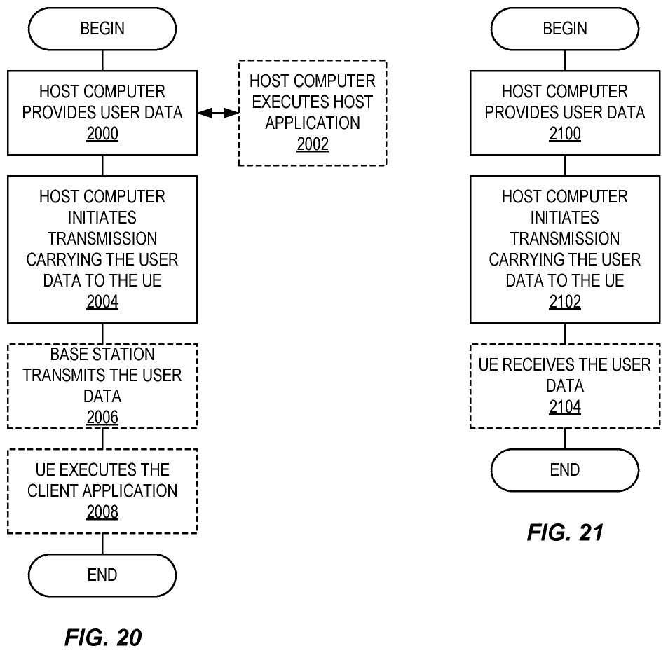

FIG. 20 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 20 will be included in this section. In step 2000, the host computer provides user data. In sub-step 2002 (which may be optional) of step 2000, the host computer provides the user data by executing a host application. In step 2004, the host computer initiates a transmission carrying the user data to the UE. In step 2006 (which may be optional), the base station transmits to the UE the user data which was carried in the transmission that the host computer initiated, in accordance with the teachings of the embodiments described throughout this disclosure. In step 2008 (which may also be optional), the UE executes a client application associated with the host application executed by the host computer.

FIG. 21 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 21 will be included in this section. In step 2100 of the method, the host computer provides user data. In an optional sub-step (not shown) the host computer provides the user data by executing a host application. In step 2102, the host computer initiates a transmission carrying the user data to the UE. The transmission may pass via the base station, in accordance with the teachings of the embodiments described throughout this disclosure. In step 2104 (which may be optional), the UE receives the user data carried in the transmission.

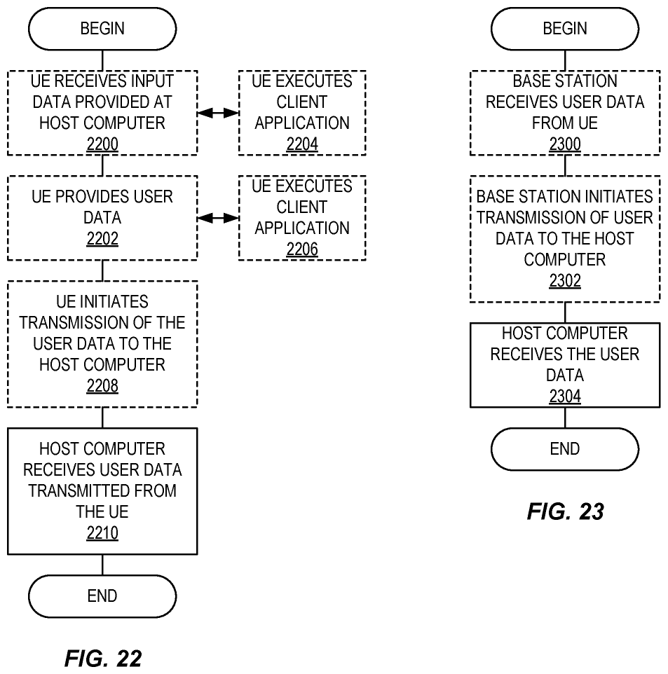

FIG. 22 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 22 will be included in this section. In step 2200 (which may be optional), the UE receives input data provided by the host computer. Additionally or alternatively, in step 2202, the UE provides user data. In sub-step 2204 (which may be optional) of step 2200, the UE provides the user data by executing a client application. In sub-step 2206 (which may be optional) of step 2202, the UE executes a client application which provides the user data in reaction to the received input data provided by the host computer. In providing the user data, the executed client application may further consider user input received from the user. Regardless of the specific manner in which the user data was provided, the UE initiates, in sub-step 2208 (which may be optional), transmission of the user data to the host computer. In step 2210 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 23 will be included in this section. In step 2300 (which may be optional), in accordance with the teachings of the embodiments described throughout this disclosure, the base station receives user data from the UE. In step 2302 (which may be optional), the base station initiates transmission of the received user data to the host computer. In step 2304 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: The method of any of the embodiments of a method performed by a wireless communication device described herein (or claimed in the Claims below), further comprising: providing user data; and forwarding the user data to a host computer via the transmission to the network node.

Embodiment 2: The method performed by a network node in accordance with any of the embodiments described herein (or claimed in the Claims below), further comprising: obtaining user data; and forwarding the user data to a host computer or a wireless communication device.

Embodiment 3: A wireless communication device, the wireless communication device comprising: processing circuitry configured to perform any of the steps of any of the embodiments of a method performed by a wireless communication device described herein (or claimed in the Claims below); and power supply circuitry configured to supply power to the wireless communication device.

Embodiment 4: A base station comprising: processing circuitry configured to perform any of the steps of any of the Embodiments of a method performed by a network node described herein (or claimed in the Claims below); and power supply circuitry configured to supply power to the base station.

Embodiment 5: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Embodiments of a method performed by a wireless communication device described herein (or claimed in the Claims below); an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 6: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Embodiments of a method performed by a network node described herein (or claimed in the Claims below).

Embodiment 7: The communication system of the previous embodiment further including the base station.

Embodiment 8: The communication system of the previous 2 embodiments, further including the UE, wherein the UE is configured to communicate with the base station.

Embodiment 9: The communication system of the previous 3 embodiments, wherein: the processing circuitry of the host computer is configured to execute a host application, thereby providing the user data; and the UE comprises processing circuitry configured to execute a client application associated with the host application.

Embodiment 10: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Embodiments of a method performed by a network node described herein (or claimed in the Claims below).

Embodiment 11: The method of the previous embodiment, further comprising, at the base station, transmitting the user data.

Embodiment 12: The method of the previous 2 embodiments, wherein the user data is provided at the host computer by executing a host application, the method further comprising, at the UE, executing a client application associated with the host application.

Embodiment 13: A User Equipment, UE, configured to communicate with a base station, the UE comprising a radio interface and processing circuitry configured to perform the method of the previous 3 embodiments.

Embodiment 14: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Embodiments of a method performed by a wireless communication device described herein (or claimed in the Claims below).

Embodiment 15: The communication system of the previous embodiment, wherein the cellular network further includes a base station configured to communicate with the UE.

Embodiment 16: The communication system of the previous 2 embodiments, wherein: the processing circuitry of the host computer is configured to execute a host application, thereby providing the user data; and the UE's processing circuitry is configured to execute a client application associated with the host application.

Embodiment 17: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Embodiments of a method performed by a wireless communication device described herein (or claimed in the Claims below).

Embodiment 18: The method of the previous embodiment, further comprising at the UE, receiving the user data from the base station.

Embodiment 19: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Embodiments of a method performed by a wireless communication device described herein (or claimed in the Claims below).

Embodiment 20: The communication system of the previous embodiment, further including the UE.

Embodiment 21: The communication system of the previous 2 embodiments, further including the base station, wherein the base station comprises a radio interface configured to communicate with the UE and a communication interface configured to forward to the host computer the user data carried by a transmission from the UE to the base station.

Embodiment 22: The communication system of the previous 3 embodiments, wherein: the processing circuitry of the host computer is configured to execute a host application; and the UE's processing circuitry is configured to execute a client application associated with the host application, thereby providing the user data.

Embodiment 23: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 24: A method implemented in a communication system including a host computer, a base station, and a User Equipment, UE, the method comprising: at the host computer, receiving user data transmitted to the base station from the UE, wherein the UE performs any of the steps of any of the Embodiments of a method performed by a wireless communication device described herein (or claimed in the Claims below).

Embodiment 25: The method of the previous embodiment, further comprising, at the UE, providing the user data to the base station.

Embodiment 26: The method of the previous 2 embodiments, further comprising: at the UE, executing a client application, thereby providing the user data to be transmitted; and at the host computer, executing a host application associated with the client application.

Embodiment 27: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 28: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Embodiments of a method performed by a network node described herein (or claimed in the Claims below).

Embodiment 29: The communication system of the previous embodiment further including the base station.

Embodiment 30: The communication system of the previous 2 embodiments, further including the UE, wherein the UE is configured to communicate with the base station.

Embodiment 31: The communication system of the previous 3 embodiments, wherein: the processing circuitry of the host computer is configured to execute a host application; and the UE is configured to execute a client application associated with the host application, thereby providing the user data to be received by the host computer.

Embodiment 32: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Embodiments of a method performed by a wireless communication device described herein (or claimed in the Claims below).

Embodiment 33: The method of the previous embodiment, further comprising at the base station, receiving the user data from the UE.

Embodiment 34: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device for a cellular communications system, the method comprising:
receiving, from a network node, information that configures a control resource set, CORESET, for the wireless communication device, the CORESET comprising four or more symbols in the time domain; and
receiving a physical downlink control channel, PDCCH, transmission from the network node within a search space that comprises at least a subset of time-frequency resources within the CORESET.

2. The method of claim 1 wherein a first Control Channel Element to Resource Element Group, CCE-REG, mapping is used for the CORESET when an aggregation level, AL, is greater than an AL threshold (Y) and, otherwise, a second CCE-REG mapping is used.

3. The method of claim 2 wherein the first CCE-REG mapping involves four or more symbols in the time domain, and wherein the second CCE-REG mapping involves at most three symbols in the time domain.

4. The method of claim 2 wherein the AL threshold (Y) is a function of a number of resource blocks, RBs, comprised in the CORESET in the frequency domain.

5. The method of claim 2 wherein a number of resource blocks, RBs, comprised in the CORESET in the frequency domain is 12, and the AL threshold (Y) is 4.

6. The method of claim 2 wherein a number of resource blocks, RBs, comprised in the CORESET in the frequency domain is 18, and the AL threshold (Y) is 8.

7. The method of claim 2 wherein a number of resource blocks, RBs, comprised in the CORESET in the frequency domain is 24, and the AL threshold (Y) is 8.

8. The method of claim 2 wherein a number of resource blocks, RBs, comprised in the CORESET in the frequency domain is 30, and the AL threshold (Y) is 8.

9. The method of claim 1 wherein a CCE-REG mapping for the CORESET is based on or derived from CCE-REG mappings for two or more CORESETs, wherein each of said two or more CORESETs comprises three or less Orthogonal Frequency Division Multiplexing, OFDM, symbols.

10. The method of claim 9 wherein said two or more CORESETs are K CORESETs, each mapped to N symbols in each of K slots that are combined to provide the CORESET as a N·K symbol CORESET.

11. The method of claim 9 wherein said two or more CORESETs are K CORESETs, each mapped to N consecutive symbols in each of K consecutive slots that are combined to provide the CORESET as a N·K symbol CORESET spanning a time duration of K slots.

12. The method of claim 9 wherein said two or more CORESETs are K CORESETs, each mapped to N consecutive symbols in each of K slots that are combined to provide the CORESET as a N·K symbol CORESET, and the K slots are every Mth slot during a time span of KM of M·K slots such that the CORESET spans M·K slots.

13. The method of claim 9 wherein said two or more CORESETs are K CORESETs, each mapped to N symbols in each of K slots that are combined to provide the CORESET as a N·K symbol CORESET, and the K slots are every Mth slot during a time span of KM of M·K slots such that the CORESET spans M·K slots.

14. The method of claim 9 wherein each of said two or more CORESETs is a Third Generation Partnership Project, 3GPP, Release 15 CORESET.

15-20. (canceled)

21. The method of claim 1 further comprising:
receiving, from the network node, information that configures a search space for the wireless communication device that comprises at least a subset of time-frequency resources within the CORESET,
wherein the search space is a number of PDCCH candidates within the CORESET that the wireless communication device is configured to monitor, and wherein receiving the PDCCH transmission comprises receiving the PDCCH transmission within the search space.

22-26. (canceled)

27. A wireless communication device for a cellular communications system, the wireless communication device comprising:
one or more transmitters;
one or more receivers; and
processing circuitry associated with the one or more transmitters and the one or more receivers, the processing circuitry configured to cause the wireless communication device to:
receive, from a network node, information that configures a control resource set, CORESET, for the wireless communication device, the CORESET comprising four or more symbols in the time domain; and
receive a physical downlink control channel, PDCCH, transmission from the network node within a search space that comprises at least a subset of time-frequency resources within the CORESET.

28-60. (canceled)

61. A method performed by a network node for a cellular communications system, the method comprising:
providing, to a wireless communication device, information that configures a Control Resource Set, CORESET, for the wireless communication device, the CORESET comprising four or more symbols in the time domain.

62-87. (canceled)

88. A network node for a cellular communications system, the network node comprising processing circuitry configured to cause the network node to:
provide, to a wireless communication device, information that configures a Control Resource Set, CORESET, for the wireless communication device, the CORESET comprising four or more symbols in the time domain.

89-121. (canceled)
